(19) United States
(12) Patent Application Publication
(10) Pub. No.: US 2020/0389093 A1
(43) Pub. Date: Dec. 10, 2020

(54) SWITCHED MODE POWER CONVERTER AND CONVERSION METHOD

(71) Applicant: SIGNIFY HOLDING B.V., EINDHOVEN (NL)

(72) Inventors: JACOB TIETEMA, EINDHOVEN (NL); PAUL ROBERT VELDMAN, OSS (NL); BERNHARD CHRISTIAAN VAN DIJK, GELDROP (NL)

(21) Appl. No.: 16/763,805

(22) PCT Filed: Nov. 12, 2018
(86) PCT No.: PCT/EP2018/080861

§ 371 Date: May 13, 2020

(30) Foreign Application Priority Data
Nov. 15, 2017 (CN) PCT/CN2017/111129
Jan. 3, 2018 (EP) 18150143.8

(51) Int. Cl. H02M 3/335; H05B 45/382; H05B 45/385; H02M 1/08

(52) U.S. Cl. CPC H02M 3/33523; H05B 45/382; H02M 2001/0025; H02M 1/08; H05B 45/385

(57) ABSTRACT

A switch mode power converter has a transformer for isolating the output and an opto-isolator for providing both voltage and current feedback. A light source of the opto-isolator is in series between first and second adjustment signals, wherein one is based on current sensing and the other is based on voltage sensing. A light detector of the opto-isolator provides an isolated feedback signal for controlling the converter.

### FIELD OF THE INVENTION

This invention relates to switched mode power converters, They may be used for providing DC to DC conversion, for example after initial AC to DC rectification, or else they may be used for delivering an AC output.

### BACKGROUND OF THE INVENTION

Switched mode power supplies are used widely in LED driver circuits.

Controllable drivers may be used to vary the voltage and/or current supply provided to a load. One known use of such controllable drivers is to controllably dim an LED output load. In such drivers, there is typically a primary converter adapted to receive and convert an input supply in response to at least one desired supply signal from control circuitry. The control circuitry typically generates the at least one desired supply signal from at least one input control signal. The primary converter and the output load are usually isolated from one another by a pair of magnetically coupled windings.

It is known to isolate the control circuitry, which generates at least one desired supply signal, from the primary converter with an opto-isolator.

FIG. 1 shows an exemplary prior art topology of a known driver 10. A flyback converter topology is shown, which is known for use in both AC/DC and DC/DC conversion with galvanic isolation between the input and any outputs. The flyback converter is a buck-boost converter with the inductor split to form a transformer, thus combining the advantage of scaling primary-to-output voltages while also achieving isolation. The controllable driver 10 comprises the primary converter 12, the control circuitry 14 and an opto-isolator 16.

The primary converter 12 receives and converts an input supply Vsᵤp using a power generator 13 to generate a supply signal Vload for provision to a load 18. The primary converter 12 and the output load 18 are electrically isolated from one another by a first winding 20 and a second winding 22, magnetically coupled together by a shared magnetic core 24. The level of the supply signal (voltage Vlₒₐd and/or current) is adjustable by the power generator 13 in response to an adjustment signal, Vₐd. The control circuitry 14 generates an error signal from a sense signal Ifb or Vfb (shown only schematically in FIG. 1) and a reference signal, and from this error signal the adjustment signal Vad is derived using comparison circuitry. In the example shown, a dimming interface 26 receives an input voltage Vin and generates the reference voltage used by the control circuitry 14 to generate the error signal and then the adjustment signal Vad. The adjustment signal Vad is provided to the primary converter 12 by the control circuitry 14 via the opto-isolator 16. Thus, the adjustment signal implements current or voltage feedback control.

The sense signal Ifb or Vfb in this example is directly connected to the control circuitry 14, and in particular comparison circuitry of the control circuitry, from the second winding 22 (i.e. from the isolated supply signal supplied to the load).

The driver, therefore, delivers a controllable output supply signal (voltage and/or current) to the load, whilst ensuring isolation of the load from the primary converter. The control circuitry used to control the output supply is also isolated from the primary converter.

The feedback control implemented by the controller 14 may be for regulating the output voltage or current. Some lighting loads require current regulation and others require voltage regulation. Thus, current sensing and feedback control or voltage sensing and feedback control are both possible.

A lighting driver which is able to monitor and control both current and voltage would be desired.

By way of example, the driver may supply just a single LED load and deliver a controlled current to that load. In some of those cases, the driver can deliver high current at lower voltages across the load, but only a lower current at higher voltages across the load, effectively limiting/maximizing the power that is (or can be) delivered to the load. If a (single) LED load may become disconnected from the driver, the driver output voltage must be limited to a safe level (i.e. safe for driver itself, and safe for its application environment). In other cases, multiple LED loads might be connected in parallel, each LED load having its own, local DC-DC converter. In those cases, it may be desired to deliver a fixed voltage to all parallel-connected loads.

Thus, there are situations in which it is preferable to be able to implement either a current regulation control loop or a voltage regulation control loop. There are different known ways to implement both feedback regulation loops to a single overall controller.

Basically, a first feedback path delivering a voltage adjustment signal and a second feedback path delivering a current adjustment signal, are required. In a first approach, these signals can be combined by current summing at a junction node, wherein when one feedback path is not active it is turned off to deliver no current to the node. In a second approach, these signals can be combined by having one control as reference input for the other, thereby providing a cascaded circuit.

These approaches have difficulties in terms of the speed of response of the circuit to switching between modes and/or difficulties in achieving a desired frequency response.

There is therefore a need for an isolated switch mode power converter design which enables switching between current regulation and voltage regulation in an efficient manner.

### SUMMARY OF THE INVENTION

The invention is defined by the claims.

According to examples in accordance with an aspect of the invention, there is provided a switch mode power converter, comprising:

an isolating transformer having an input winding and an output winding;

a main control switch for controlling the flow of current through the input winding;

a control circuit for controlling the main control switch;

an output circuit connected to the output winding, the output circuit having an output for connection to a load, wherein the output circuit is adapted to generate a first adjustment signal based on the output voltage and a second adjustment signal based on the output current; and

an opto-isolator comprising a light source and a light detector, wherein the light source is in series between the first and second adjustment signals, and wherein the light detector provides an isolated feedback signal to the control circuit.

This power converter design has current and voltage feedback provided through a shared opto-isolator. The light source of the opto-isolator (which converts the final feedback signal to an optical signal) is connected between the two adjustment signals. Voltage control or current control are active at any one time, and the other feedback system then simply delivers a saturated output (i.e. at a supply voltage of an amplifier in the feedback loop) which functions as a fixed reference. In this way, it is possible to make smooth transitions between the two feedback control approaches.

The two control modes are of interest to enable a set point to be provided for the (maximum) current, and for the (maximum) voltage. It is ultimately the load that is connected that determines which control mode is active.

A “high ohmic” load would result in too high voltage if the full driver current could flow, and hence voltage control is active. Conversely, a “low ohmic” load would conduct too much current if the full driver voltage could be applied, and hence current control is active.

When disconnecting a load, a large overshoot in output voltage will occur if the first (voltage) adjustment signal slowly increases and only becomes “active” if it has become larger than the second (current) adjustment signal. Conversely, when connecting a load, a current overshoot will occur if the second (current) adjustment signal slowly increases and only becomes “active” if it has become larger than the first (voltage) adjustment signal. Thus, limiting of both current and voltage assists in providing safety during connection and disconnection of the load.

When operating a load very close to both the current and the voltage reference levels, very small changes (for example supply voltage changes caused by a 100 Hz ripple, or temperature changes) can cause continuous or incidental transitions between voltage and current feedback modes and vice-versa. Particularly if the load is a light source, overshoots during those transitions might otherwise result in visible artifacts or flicker.

The output circuit for example comprises a resistive divider for generating an output voltage sense signal.

A first error amplifier may then be provided for generating the first (voltage) adjustment signal from the output voltage sense signal and a first reference input. For example, an error signal may be generated which represents the deviation of the output voltage from a desired target level, and the adjustment signal may then be generated from the error signal by the first error amplifier.

The converter preferably has a current control mode and a voltage control mode, wherein when in the current control mode the first error amplifier is in saturation. This means that the first error amplifier is able to be switched into operation quickly by coming out of saturation.

The output circuit may comprise a current sense resistor for generating an output current sense signal.

A second error amplifier may then be provided for generating the second (current) adjustment signal from the output current sense signal and a second reference input. Again, an error signal may be generated which represents the deviation of the output current from a desired target level and the adjustment signal may then be generated from the error signal by the second error amplifier.

The converter preferably has a current control mode and a voltage control mode, wherein when in the voltage control mode the second error amplifier is in saturation. This means that the second error amplifier is able to be switched into operation with the opto-coupler feedback signal responding immediately.

The light source of the opto-isolator is then in series between the outputs of the error amplifiers, which are the two adjustment signals. Note that the term “in series between the first and second adjustment signals” does not exclude additional signal processing elements in the series path.

The converter for example comprises a resistor in series with the light source. This sets the current through the light source to a suitable level for the correct operation of the opto-isolator.

The control circuit is for example adapted to apply pulse width/frequency/density modulation to a switch terminal of the main control switch. This controls the switch mode power conversion process to regulate the output current or voltage.

The invention also provides a lighting circuit comprising:

a switch mode power converter as defined above; and

an LED lighting load connected to the output of the output circuit.

The lighting circuit may further comprise an AC/DC converter (such as a rectifier) at an input of the switch mode converter. The lighting circuit is thus suitable for mains connection.

The invention also provides a power conversion method using a switch mode power converter, the method comprising:

controlling the flow of current through an input winding of an isolating transformer using a main control switch thereby generating a voltage at the output winding for application to an output load;

generating a first adjustment signal based on the output voltage and a second adjustment signal based on the output current;

controlling a light source of an opto-isolator in series between the first and second adjustment signals; and

using a light detector of the opto-isolator to provide an isolated feedback signal for use in controlling the main control switch.

This method enables smooth switching transitions between current control and voltage control of a load. The method may comprise operating the switch mode power converter in one of a current control mode and a voltage control mode.

The first (voltage) adjustment signal may be generated from an output voltage sense signal and a first reference input using a first error amplifier, wherein when in the current control mode the first error amplifier is in saturation. Similarly, the second (current) adjustment signal may be generated from an output current sense signal and a second reference input using a second error amplifier, wherein when in the voltage control mode the second error amplifier is in saturation.

These and other aspects of the invention will be apparent from and elucidated with reference to the embodiment(s) described hereinafter.

### BRIEF DESCRIPTION OF THE DRAWINGS

Examples of the invention will now be described in detail with reference to the accompanying drawings, in which:

FIG. 1 shows an exemplary prior art topology of a known driver;

FIG. 2 shows a first possible approach to provide current and voltage feedback;

FIG. 3 shows a second possible approach to provide current and voltage feedback;

FIG. 4 shows a switch mode power converter in accordance with one example of the invention; and

FIG. 5 shows a power conversion method.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a switch mode power converter which has a transformer for isolating the output and an opto-isolator for providing both voltage and current feedback. A light source of the opto-isolator is in series between a first adjustment signal (obtained based on voltage sensing) and a second adjustment signal (obtained based on current sensing). A light detector of the opto-isolator provides an isolated feedback signal for controlling the converter.

As mentioned above, there are different possible ways to provide current and voltage feedback and control.

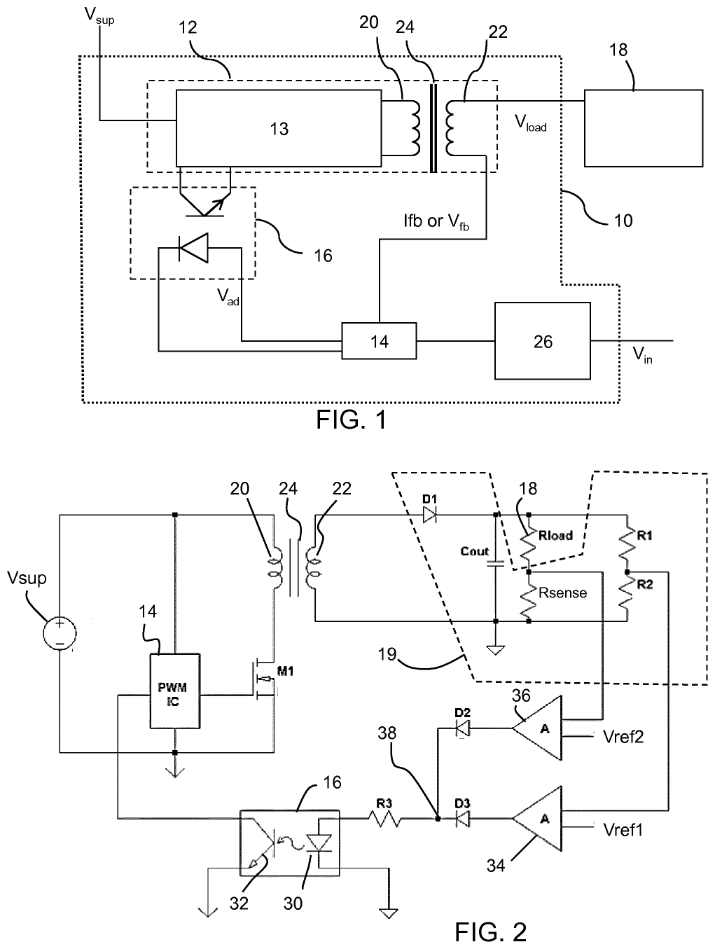

FIG. 2 shows a first possible approach. The same reference numbers are used as in FIG. 1 for the same components.

The output winding 22 connects to an output capacitor Cout through a flyback diode D1.

The load 18 is represented schematically by a resistor Rload. The load may for example comprise an LED arrangement. The load is driven by an output circuit 19 comprising the flyback diode D1 and output capacitor Cout.

A resistive divider R1, R2 generates an output voltage sense signal based on the output voltage, and a current sense resistor Rsense in series with the load Rload is used to generate an output current sense signal (as a voltage) based on the output current through the load. Note that the error amplifiers 34, 36 (discussed below) may include PI, PD or PID dynamic control behavior via a compensation network. The output circuit 19 may also be considered to include the current sense resistor Rsense and the resistive divider R1, R2, as shown.

FIG. 2 shows a single main control switch M1 in the form of a MOS transistor for controlling the flow of current through the input winding 20. The control circuit 14 is for controlling the control terminal (gate) of the main control switch. Optionally, it might implemented dynamic behavior using PID, PD or PI control, or such dynamic behavior may be implemented in the output side control circuitry.

The opto-isolator 16 is shown to comprise a light source 30 and a light detector 32.

The voltage divider output (the output voltage sense signal) is provided to a first error amplifier 34 for comparison with a first reference voltage Vref1 to generate a first adjustment signal.

The current sense resistor output (the output current sense signal) is provided to a second error amplifier 36 for comparison with a second reference voltage Vref2 to generate a second adjustment signal.

In this description, the term “current/voltage sense signal” is used to denote the signal which is the input to the error amplifiers, and the term “first/second adjustment signal” is used to denote the output of the error amplifiers. The eventual feedback control is based on these adjustment signals.

Two control circuits are required, one for the current mode control, and one for voltage mode control. The arrangement of FIG. 2 combines the voltage and current mode control by providing the two adjustment signals to a junction node 38 through diodes D2 and D3.

Via diodes D2 and D3, the highest of the two output voltages of the two error amplifiers 34, 36 feed the node 38 and thus (via the resistor R3) feed the opto-isolator light source 30. The diode connecting the lowest of the two voltages of the two error amplifiers will then simply block and not conduct current (other than potentially any leakage current).

This parallel control approach using diodes is most commonly implemented in LED drivers, but it has the drawback that it takes some time until control takes over from the voltage mode control to the current mode control (or vice versa). This time delay can result in a large current or voltage overshoot, which is not desired.

For the example of FIG. 2, the voltage and current sense signals (from the resistive divider R1, R2 or the current sense resistor Rsense) are connected to the positive input of the respective amplifier 34 and 36 and the reference signals Vref1 and Vref2 are connected to the negative (inverting) input of the respective amplifier 34, 36. Thus, if the sense signal is higher than the reference signal, the “adjustment signal” at the output of amplifier will be or become (dynamic behavior) more positive and thus will increase the opto-isolator light source activation.

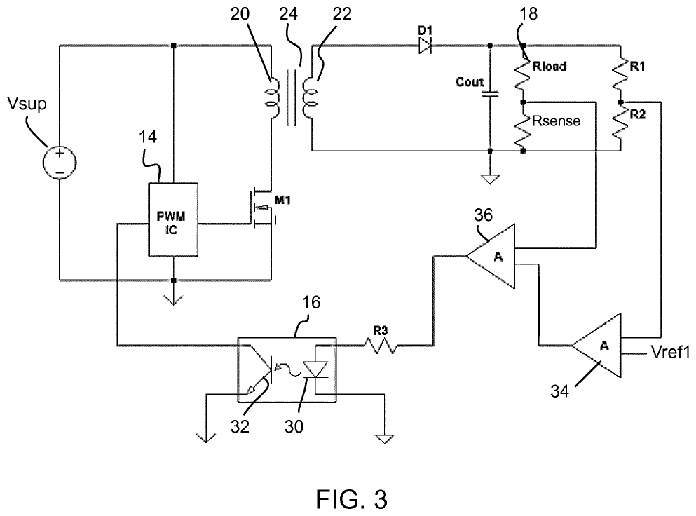

FIG. 3 shows an approach based on a cascaded control circuit. The same reference numbers are used as in FIG. 2 for the same components.

In this circuit, the first error amplifier 34 supplies its output (the first adjustment signal) as the reference input to the second error amplifier 36 which then generates the second adjustment signal which then functions as the final feedback signal. In practice, a voltage divider stage may be present between the amplifiers, or integrated into the output stage of the amplifier 34. This circuit exhibits lower voltage and current overshoots than the circuit of FIG. 2 but has the disadvantage that it is less flexible to implement; i.e. the frequency response of the voltage mode control loop is not independent of the frequency response of the current mode control loop (and vice versa). This makes cascaded control difficult to design, and only applicable for a small variety of application.

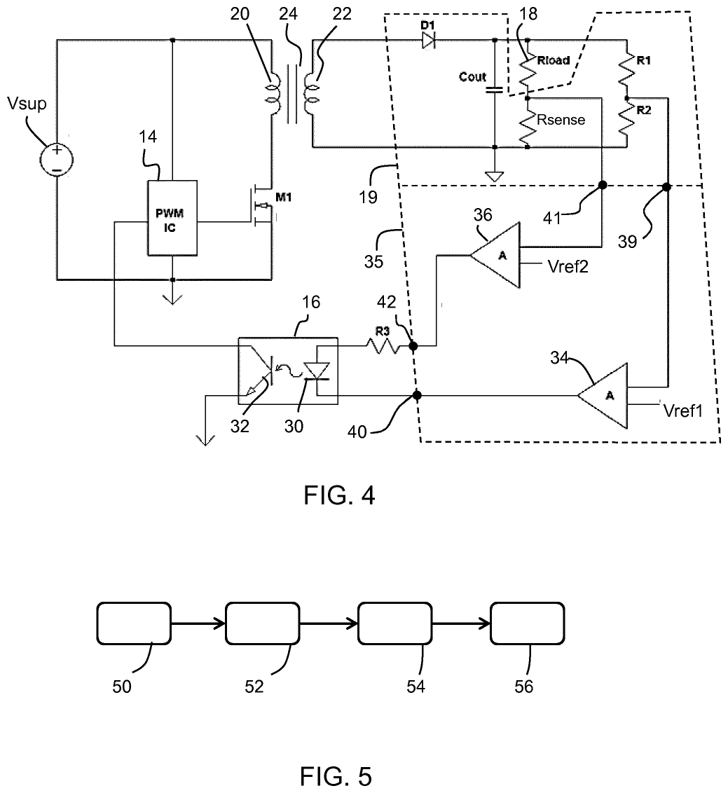

FIG. 4 shows a switch mode power converter in accordance with the invention. The same reference numbers are used as in FIGS. 2 and 3 for the same components.

In this circuit, the light source 30 of the opto-isolator is in series between the first and second adjustment signals. The signal (voltage) 40 is the first (voltage) adjustment signal and the signal (voltage) 42 is the second (current) adjustment signal. These adjustment signals are the outputs of the first and second error amplifiers 34, 36, which together form a feedback circuit 35. The output voltage sense signal, based on the output voltage, is at the output 39 of the resistive divider and the output current sense signal, based on the output current, is at the output 41 of the current sense resistor. These are the inputs to the error amplifiers 34, 36 which generate the adjustment signals. These adjustment signals are each obtained based on deriving an error signal and processing the error signal as explained above. The two adjustment signals are combined to form the eventual feedback signal (i.e. the signal driving the opto-isolator) by placing them in series with the light source 30 as explained above.

The invention thus provides a secondary side, series-control circuit for current and voltage mode control. During control, one error amplifier (implemented as an op-amp) has an output voltage in saturation, while the other is controlling the LED driver's output current or voltage. When making a transition from current mode control to voltage mode control (or vice versa), the saturated op-amp can immediately change the opto-isolator light source activation when relaxing from its saturated output voltage state. The saturated output state is when the output voltage of the amplifier is close to one of the supply terminal voltages of the amplifier.

The reference voltages Vref1 and Vref2 remain constant when making a transition between modes. However, for a dimmable LED driver, the Vref2 current reference may be controlled via a wired or wireless interface to implement dimming control.

The advantage compared to the parallel control of FIG. 2 is that the global feedback control loop (i.e. up to the output of the opto-isolator) is able to react immediately when there is a transition in control mode and the previously saturated error amplifier exits its saturated condition. The parallel control circuit of FIG. 2 takes some time until the second error amplifier takes over control.

Bandwidth matching between the current and voltage control loops is preferably provided for minimum current or voltage overshoot.

The control circuit also exhibits lower current and voltage overshoot compared to typical implemented circuits, specifically when undergoing a transition from voltage mode control to current mode control or vice versa. This reduces voltage and current stress of components in the LED driver, and thereby improves its lifetime and reliability.

A resistor R3 is again in series with the light source 30 so that the voltage difference between the first (voltage) adjustment signal 40 and the second (current) adjustment signal 42 (one of which functions as a saturated reference) delivers a suitable current for activating the light source.

In combination with the load 18, which may be a series or series and parallel arrangement of LEDs, a lighting circuit is formed. The lighting circuit may further comprise an AC/DC converter such as a full bridge rectifier for converting a mains input to the DC voltage Vsup for switched supply to the input winding 20.

The circuit of FIG. 4 may use the same polarity connections to the error amplifiers as explained with reference to FIG. 2. When in the current control mode, the error amplifier 34 will saturate to its “low” state while allowing the output of error amplifier 36 to assume a higher, non-saturated voltage.

When in the voltage control mode, the output of the error amplifier 36 is saturated in its “low” state and the error amplifier 34 will assume a higher, non-saturated voltage.

This means the polarity of the difference between the outputs of the two error amplifiers (the “adjustment signals”) will change. This requires the light source 30 of the opto-isolator to be able to generate light, independent of the polarity of the current flow. This can be achieved by using a dual light-source opto-isolator instead of the single LED as schematically shown, or by placing the opto-isolator light source, possibly together with the resistor R3, in a diode bridge rectifier.

The circuit of FIG. 4 may instead use a different polarity scheme for the error amplifiers. The input polarity of (either) one of the two error amplifiers 34 and 36 may be inverted. For example, the polarity of the voltage error amplifier 34 is inverted by connecting the output voltage sense signal 39 to the inverting input and the Vref1 reference signal to the positive (non-inverting) input of the error amplifier 34.

In this way, if neither the output voltage sense signal nor the output current sense signal exceeds their respective reference signals, the output of the error amplifier 34, i.e. the voltage adjustment signal, saturates in its “high” state, while the output of the error amplifier 36, i.e. the current adjustment signal, saturates in its “low” state. In this way, the opto-isolator light source is fully activated and thus actively demanding increased output voltage and current to the maximum extent.

Thus, depending on the exact implementation of the invention, there are different options for the way the error amplifiers are connected.

In a first embodiment the feedback signal can indicate the output power to the control circuit 14 that will determine the adjustment.

In another embodiment, it is possible to have a reverse feedback control wherein the feedback control can indicate a request of power increase at the output while a low value indicate to maintain the current power and an absence of signal indicate a fault detection to the control circuit. The use of the circuit of FIG. 4 is suitable for any kind of feedback management.

FIG. 5 shows a power conversion method using a switch mode power converter, the method comprising:

in step 50, controlling the flow of current through an input winding of an isolating transformer using a main control switch thereby transferring energy to the output winding for application to an output load;

in step 52 generating a first, voltage adjustment signal based on the output voltage and a second, current adjustment signal based on the output current;

in step 54 controlling a light source of an opto-isolator in series between the first and second adjustment signals; and

in step 56 using a light detector of the opto-isolator to provide an isolated feedback signal for use in controlling the main switch.

The switch mode power converter is operated in one of a current control mode and a voltage control mode.

The step 52 for example comprises generating the first adjustment signal 40 from an output voltage sense signal 39 and a first reference input Vref1 using a first error amplifier 34 and generating the second adjustment signal 42 from an output current sense signal 41 and a second reference input Vref2 using a second error amplifier 36. When in the voltage control mode the second error amplifier is in saturation and when in the current control mode the first error amplifier is in saturation.

In many types of power supplies, most of which have an isolated output, it is well known to have a voltage limit or control, and a current limit or control. LED drivers are mostly used as voltage limited current sources, whereas most other types of load (i.e. including non-lighting loads) require a supply that is used as a current limited voltage source.

The example above shows a single output winding, but other examples may make use of multiple windings. The circuit is shown with a single main control switch, but there may be an arrangement of multiple control switches.

The invention may be applied to isolated square-wave converters such as flyback converters or resonant converters. Resonant converters typically have two main switches.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A switch mode power converter, comprising:
an isolating transformer having an input winding and an output winding;
a main control switch (M1) for controlling the flow of current through the input winding;
a control circuit for controlling the main control switch;
an output circuit connected to the output winding, the output circuit having an output for connection to a load, wherein the switch mode converter comprises a first error amplifier adapted to generate a first, voltage adjustment signal based on the output voltage and a second error amplifier adapted to generate a second, current adjustment signal based on the output current; and
an opto-isolator comprising a light source and a light detector, wherein the light source is in series between an output of the first error amplifier and an output of the second error amplifier, and wherein the light detector provides an isolated feedback signal to the control circuit.

2. A switch mode power converter as claimed in claim 1, wherein the output circuit comprises a resistive divider (R1, R2) for generating an output voltage sense signal.

3. A switch mode power converter as claimed in claim 2, wherein the first error amplifier (34) is arranged to generate the first adjustment signal from the output voltage sense signal and a first reference input (Vref1).

4. A switch mode power converter as claimed in claim 3, wherein the converter has a current control mode and a voltage control mode, wherein when in the current control mode the first error amplifier is in saturation.

5. A switch mode power converter as claimed in claim 1, wherein the output circuit comprises a current sense resistor (Rsense) for generating an output current sense signal.

6. A switch mode power converter as claimed in claim 5, wherein the second error amplifier is arranged to generate the second adjustment signal from the output current sense signal and a second reference input (Vref2).

7. A switch mode power converter as claimed in claim 6, wherein the converter has a current control mode and a voltage control mode, wherein when in the voltage control mode the second error amplifier is in saturation.

8. A switch mode power converter as claimed in claim 1, comprising a resistor (R3) in series with the light source.

9. A switch mode power converter as claimed in claim 1, wherein the control circuit is adapted to apply pulse width modulation or pulse frequency modulation or pulse density modulation to a switch terminal of the main control switch (M1).

10. A lighting circuit comprising:
a switch mode power converter as claimed in claim 1; and
an LED lighting load connected to the output of the output circuit.

11. A lighting circuit as claimed in claim 10, further comprising an AC/DC converter at an input of the switch mode power converter.

12. A power conversion method using a switch mode power converter, the method comprising:
controlling the flow of current through an input winding of an isolating transformer using a main control switch thereby generating a voltage at an output winding of the isolating transformer for application to an output load;
generating a first, voltage adjustment signal based on the output voltage and a second, current adjustment signal based on the output current; and
controlling a light source of an opto-isolator in series between the first and second adjustment signals; and
using a light detector of the opto-isolator to provide an isolated feedback signal for use in controlling the main control switch.

13. A method as claimed in claim 12, comprising operating the switch mode power converter in one of a current control mode and a voltage control mode.

14. A method as claimed in claim 13, comprising generating the first adjustment signal from an output voltage sense signal and a first reference input using a first error amplifier, wherein when in the current control mode the first error amplifier is in saturation.

15. A method as claimed in claim 13, comprising generating the second adjustment signal from an output current sense signal and a second reference input using a second error amplifier, wherein when in the voltage control mode the second error amplifier is in saturation.
